(19) United States
(12) Patent Application Publication
(10) Pub. No.: US 2025/0018872 A1
(43) Pub. Date: Jan. 16, 2025

(54) TAILGATE PAD STRAP INSTALLATION TOOL

(71) Applicant: Fox Factory, Inc., Duluth, GA (US)

(72) Inventor: Jean-François Lacroix, North Vancouver (CA)

(73) Assignee: Fox Factory, Inc., Duluth, GA (US)

(21) Appl. No.: 18/220,178

(22) Filed: Jul. 10, 2023

(51) Int. Cl. B60R 9/06

(52) U.S. Cl. CPC B60R 9/06; B60R 9/10

(57) ABSTRACT

Disclosed herein is an installation tool comprising a strap receiving portion and a retaining portion. A slot passes through the strap receiving portion and is fit to receive a strap. The retaining portion prevents the installation tool from falling through a gap.

### FIELD OF THE INVENTION

Embodiments of the present technology relate generally to a tailgate pad.

### BACKGROUND

Many trucks and other vehicles include a tailgate. In some instances, owners of tailgate-equipped vehicles will utilize the tailgate when transporting, for example, a bicycle.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 is a perspective view of an adjustable tailgate pad, in accordance with embodiments of the present invention.

FIG. 2 is a perspective view of an adjustable tailgate pad (facing the back side thereof), in accordance with embodiments of the present invention.

FIG. 3 is a perspective view of a tailgate pad disposed about a tailgate and a bicycle disposed about the tailgate pad, in accordance with embodiments of the present invention.

FIG. 4 is a perspective view of installation tool, according to an embodiment.

FIG. 5 is a side view of installation tool, according to an embodiment.

FIG. 6 is a perspective view of installation tool in a partially open position, according to an embodiment.

FIG. 7 is a perspective view of installation tool in an open position, according to an embodiment.

FIG. 8a-8e are collectively the process of using installation tool to install a tailgate pad, according to an embodiment.

FIG. 9 is a perspective view of installation tool, according to an embodiment.

FIG. 10 is a perspective view of installation tool in a curved position, according to an embodiment.

FIG. 11 is a perspective view of installation tool in a curved position, according to an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

In some instances, owners of tailgate-equipped vehicles may utilize the tailgate when transporting, for example, a bicycle. For purposes of brevity and clarity, the following discussion will refer to the tailgate of a truck. It should be understood, however, that the present embodiments are also well suited to use with a tailgate of a vehicle other than a truck. Moreover, embodiments of the present invention are well suited for use when transporting, for example, a motorcycle. Additionally, embodiments of the present adjustable tailgate pad 100 are well suited to use with other items such as, for example, a surfboard, a paddleboard, lumber or other items which may be transported in the bed of a truck. That said, for purposes of brevity and clarity, and not to be interpreted as a limitation, the following discussion will describe embodiments of the present invention while referring to a truck tailgate being used to support a bicycle.

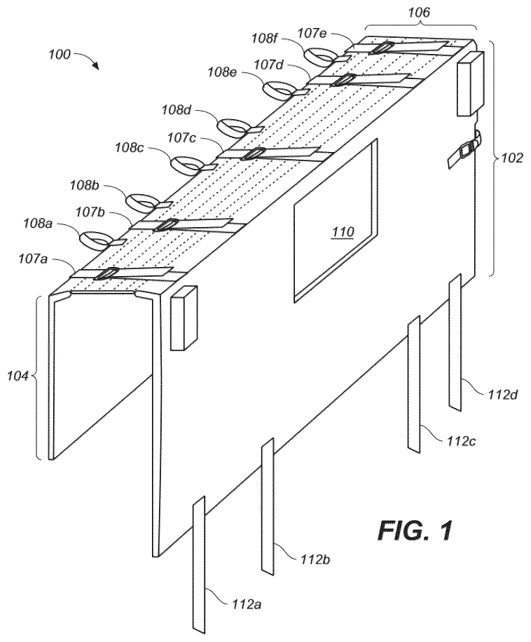

As will be described in detail below, embodiments provide an adjustable tailgate pad. Referring now to FIG. 1, a perspective view of an adjustable tailgate pad 100 is shown, in accordance with an embodiment. Adjustable tailgate pad 100 includes a front side 102, a back side 104 and a top side 106. It should be noted that each of front side 102, a back side 104 and a top side 106 are further comprised of a tailgate-facing surface and an exterior-facing surface. For purposes of brevity and clarity, and not to be interpreted as a limitation, the following discussion will describe embodiments while generally referring to front side 102, a back side 104 and a top side 106. Occasionally, the following discussion will refer to a specific tailgate-facing surface and/or exterior-facing surface of front side 102, back side 104, and/or top side 106.

In general, a tailgate pad consists of a top side that rests on the top side of a tailgate, a front side that is against the exterior facing surface of the tailgate, and a back side against the bed facing surface of the tailgate, with a plurality of straps that secure the tailgate pad to the tailgate of a vehicle. For example, front side straps 112a-d loop through gap 214 and are held in place by strap retaining feature 402a-d to secure the tailgate pad to the tailgate. While an adjustable tailgate pad is referenced, it should be understood that embodiments of the installation tool discussed herein are compatible with a variety of tailgate pads, adjustable and single sized.

In an embodiment, top side 106 of adjustable tailgate pad 100 has a plurality of top side straps, typically shown as 107a-107e, coupled thereto. Although five top side straps 107a-107e are shown in the embodiment of FIG. 1, in some embodiments, adjustable tailgate pad 100 will have more than five top side straps. Further, in some embodiments, adjustable tailgate pad 100 will have less than five top side straps. Additionally, in some embodiments, the location and/or the spacing between the plurality of top side straps 107a-107e coupled to top side 106 will differ from the location and/or spacing of top side straps 107a-107e as depicted in FIG. 1. Top side straps 107a-107e of adjustable tailgate pad 100 will be discussed further below, in detail. Top side straps 107a-107e may also be referred to as top side straps 107.

Referring still to FIG. 1, in embodiments of the present invention, adjustable tailgate pad 100 has a plurality of retaining straps, typically shown as 108a-108f, coupled thereto. In various embodiments of the present invention, retaining straps 108a-108f are used to strap a portion of a bicycle (e.g., a frame of a bicycle) against back surface 104 of adjustable tailgate pad 100. Although six retaining straps 108a-108f are shown in the embodiment of FIG. 1, in some embodiments of the present invention, adjustable tailgate pad 100 will have more than six retaining straps. Further, in some embodiments of the present invention, adjustable tailgate pad 100 will have less than six retaining straps. Additionally, in some embodiments, the location and/or the spacing between the plurality of retaining straps 108a-108f coupled to adjustable tailgate pad 100 will differ from the location and/or spacing of retaining straps 108a-108f as depicted in FIG. 1. Retaining straps 108a-108f of adjustable tailgate pad 100 will be discussed further below, in detail. Retaining straps 108a-108f may also be referred to as retaining straps 108.

With reference still to FIG. 1, in various embodiments, adjustable tailgate pad 100 includes a window 110 formed in front side 102. In various embodiments, as will be described in detail below, front side 102 has a window 110 formed therein. In various embodiments, when window 110 of front side 102 is open, window 110 will expose, for example, a tailgate handle, a tailgate-mounted backup camera, or other tailgate features. In some embodiments, window 110 of adjustable tailgate pad 100 is rectangular in shape and approximately centered about the length of front side 102. Although such a location of window 110 is shown in the embodiment of FIG. 1, in some embodiments adjustable tailgate pad 100 will have window 110 disposed in front side 102 at a location other than as depicted in FIG. 1. Further, in some embodiments window 110 of adjustable tailgate pad 100 will have a non-rectangular shape.

Adjustable tailgate pad 100 also includes a plurality of front side straps, typically shown as 112a-112d, coupled thereto. Although four front side straps 112a-112d are shown in the embodiment of FIG. 1, in some embodiments adjustable tailgate pad 100 will have more than four front side straps. Further, in some embodiments adjustable tailgate pad 100 will have less than four front side straps. Additionally, in some embodiments, the location and/or the spacing between the plurality of front side straps 112a-112d coupled to front side 102 will differ from the location and/or spacing of front side straps 112a-112d as depicted in FIG. 1.

Referring still to FIG. 1, in various embodiments, front side straps 112a-112d are used to secure adjustable tailgate pad 100 to a tailgate. In one such embodiment, front side straps 112a-112d are placed under the bottom portion of a tailgate and are then coupled with a strap receiving feature located on back side 104 of adjustable tailgate pad 100. One example of a strap receiving feature may include, but is not limited, a cinch ring, a back side strap, a portion of a hook-and-loop fastener to mate with corresponding portion of a hook-and-loop fastener on a front side strap, etc.

In some embodiments, back side 104 of adjustable tailgate pad 100 will have back side straps coupled thereto. In one such embodiment, the back side straps are placed under the bottom portion of a tailgate and are then coupled with a strap receiving feature, located on front side 102 of adjustable tailgate pad 100. In various embodiments, back side straps are used to secure adjustable tailgate pad 100 to a tailgate in a manner as was described above with respect to front side straps 112a-112d. It should be noted that in various embodiments a combination of front side straps and back side straps are used to secure adjustable tailgate pad 100 to a tailgate.

Adjustable tailgate pad 100 may also be referred to as tailgate pad 100.

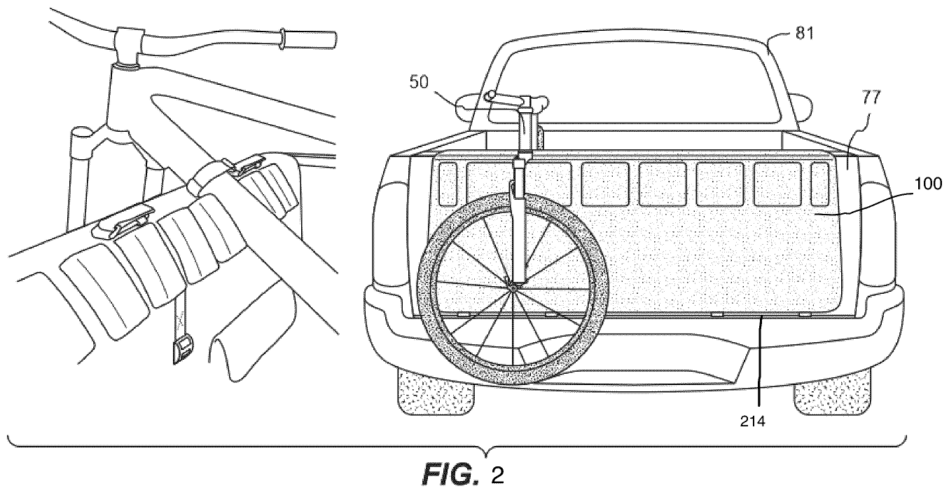

FIG. 2 is a perspective view of a tailgate pad disposed about a tailgate 77 and a bicycle 50 disposed about the tailgate pad 100. Also included is gap 214.

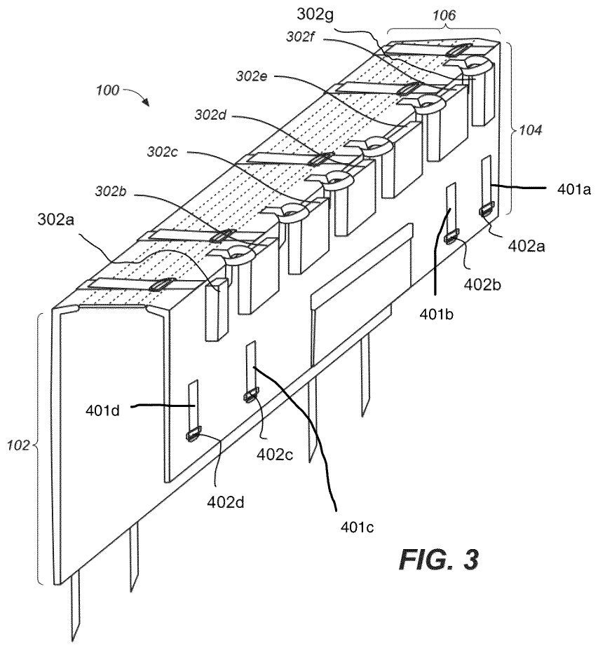

Referring now to FIG. 3, a perspective view of adjustable tailgate pad 100 (facing back side 104) is shown, in accordance with an embodiment. As shown in FIG. 3, adjustable tailgate pad 100 has a plurality of retaining blocks, typically shown as 302a-302g, coupled thereto. In various embodiments, retaining blocks 302a-302g are disposed on the exterior-facing surface of back side 104 of adjustable tailgate pad 100. In various embodiments, retaining blocks 302a-302g are used to retain and/or support a portion of a bicycle (e.g., by inserting a frame of a bicycle between two adjacent retaining blocks) in a desired position with respect to adjustable tailgate pad 100. In various embodiments, retaining blocks 302a-302g of adjustable tailgate pad 100 will retain and/or support a bicycle in an upright position. In various embodiments, retaining blocks 302a-302g are used in combination with retaining straps 108a-108f to retain and/or support a bicycle in a desired position with respect to adjustable tailgate pad 100. Additionally, in some embodiments, retaining blocks 302a-302g are used without, or in lieu of, retaining straps 108a-108f to retain and/or support a bicycle in a desired position with respect to adjustable tailgate pad 100. Furthermore, in various embodiments of the present invention, at least one of retaining straps 108a-108f includes a first feature (e.g., a hook-and-loop fastener) for removably coupling the retaining strap to adjustable tailgate pad 100 and a second feature (e.g., a hook-and-loop fastener) for coupling the retaining strap to a portion of a bicycle. In so doing, embodiments of the present adjustable tailgate pad 100 enable adjustment of the location at which retaining straps 108a-108f are coupled to adjustable tailgate pad 100. In various other embodiments of the present invention, at least one of retaining straps 108a-108f is permanently affixed to adjustable tailgate pad 100 to prevent loss of the retaining strap.

Referring still to FIG. 3, although seven retaining blocks 302a-302g are shown in the embodiment of FIG. 3, in some embodiments of the present invention, adjustable tailgate pad 100 will have more than seven retaining blocks. Further, in some embodiments of the present invention, adjustable tailgate pad 100 will have less than seven retaining blocks. Additionally, in some embodiments, the location and/or the spacing between the plurality of retaining blocks 302a-302g coupled to adjustable tailgate pad 100 will differ from the location and/or spacing of retaining blocks 302a-302g as depicted in FIG. 1.

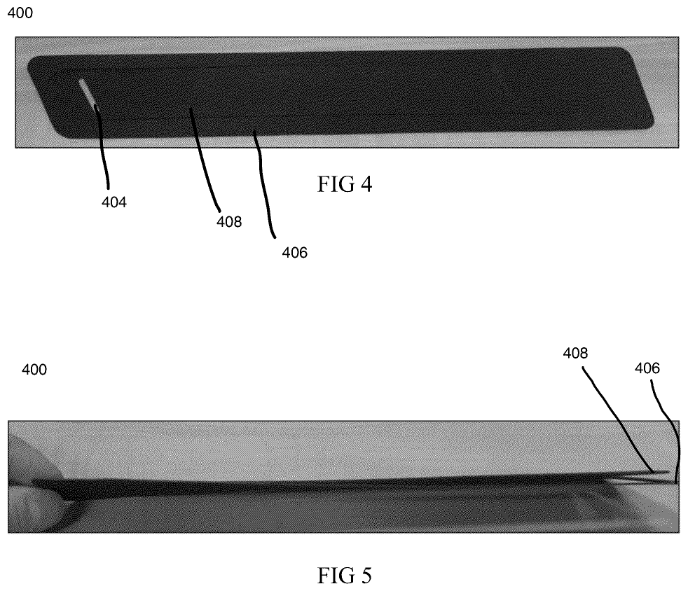

In one embodiment, the previously described strap receiving features, typically numbered 402a-402d, are coupled to back side 104 though back side straps 401a-401d. For example, strap receiving feature 402c is positioned to receive front side strap 112c to, and strap receiving feature 402d is positioned to receive front side straps 112d. Referring to the features depicted in FIG. 3, in various embodiments, as stated above, strap receiving feature 402c and front side strap 112c are used, together, to secure adjustable tailgate pad 100 to a tailgate. Similarly, strap receiving feature 402d and front side strap 112d are used, together, to secure adjustable tailgate pad 100 to a tailgate. Additionally, although strap receiving features 402a-402d are disposed on the exterior-facing surface of back side 104 in the embodiment depicted in FIG. 4, in various other embodiments, strap receiving features 402a-402d are disposed on the tailgate-facing surface of back side 104.

Often, installing the tailgate pad can be difficult with just one person. When installing a tailgate pad, often the front side straps 112a-d have to be run through gap 214 to where they are secured by strap receiving feature 402a-d. However, gap 214 is usually minimal, and in order to run front side straps 112a-d through gap 214 it is necessary to hold the tailgate at an angle to enlarge gap 214 to a point where straps 112 fit. Typically, the ideal angle to hold the tailgate at is 30-60 degrees from vertical, however the exact angle varies based on the truck model and manufacturer and can be anywhere from 0-90 degrees.

Due to this, it can be hard for a single person to hold the tailgate in a partially open position, while feeding multiple straps from outside facing to bed facing of the truck without dropping the straps, tailgate, or tailgate pad. Additionally, while struggling with multiple components the user could drop the tailgate on themselves, pinch their fingers in gap 214, or have similar mishaps that result in injury. As such, a tool to assist in installation of tailgate pads would be beneficial to those wanting to use and install one.

FIG. 4 is a perspective view of installation tool 400, according to an embodiment. Also included are slot 404, retaining portion 406, and strap receiving portion 408.

In one embodiment, installation tool 400 is made of a soft plastic, or a similarly applicable material that is rigid enough to hold its shape when being pushed through gap 214 but soft enough to bend through any bends in gap 214. In one embodiment, installation tool 400 is formed by die cut or a similar process. In one embodiment, strap receiving portion 408 and retaining portion 406 are formed from the same piece of material. In one embodiment, strap receiving portion 408 and retaining portion 406 are perforated in the manufacturing process, and an end user can break the perforation. In one embodiment, strap receiving portion 408 and retaining portion 406 are formed from different pieces of material and are coupled together (e.g., glued, sewn, melted, etc.).

The strap receiving portion 408 is meant to receive and hold tailgate pad straps, such as for example, front side straps 112a-112d as shown in at least FIG. 1, with slot 404. It should be understood that straps other than those used in the embodiment shown in at least FIG. 1 can be received, and that the embodiment in FIG. 1 is provided for clarity and brevity. Front side straps 112a-112d may also just be referred to as straps.

In one embodiment, slot 404 is slightly wider than the strap it is intended to receive. In one embodiment, slot 404 is slightly thicker than the strap it is intended to receive. For example, installation tool 400 could be designed to work with a nylon webbing strap that is 1 in wide and 25 cm thick, in which case the slot may be 1.2 in wide and 0.3 cm thick. However, the example given is for the purpose of clarity and brevity, and the dimensions of slot 404 (as well as installation tool 400) can be adjusted to fit a variety of strap sizes. In one embodiment, installation tool has at least one slot 404. In one embodiment, installation tool has a plurality of slots 404.

In one embodiment, slot 404 utilizes a crimp hold to retain front side straps 112a-112d. In one embodiment, slot 404 is slightly narrower than the target strap thickness such that front side straps 112a-112d are held in place through friction. In one embodiment, slot 404 is slightly shorter than the target strap width such that front side straps 112a-112d are held in place through friction. In one embodiment, slot 404 is slightly wider than the target strap thickness such that when the strap is pulled, friction causes the strap to bind in slot 404.

In one embodiment, there are at least two slots 404 of different dimensions, such that a single installation tool can accommodate for a variety of strap sizes. In one embodiment, there is a plurality of slots 404 with different dimensions, such that a single installation tool can accommodate for a variety of strap sizes.

FIG. 5 is a side view of installation tool 400, according to an embodiment. Installation tool 400 is of a thickness to where it can fit though gap 214, for example, of similar thickness to cardstock or a business card.

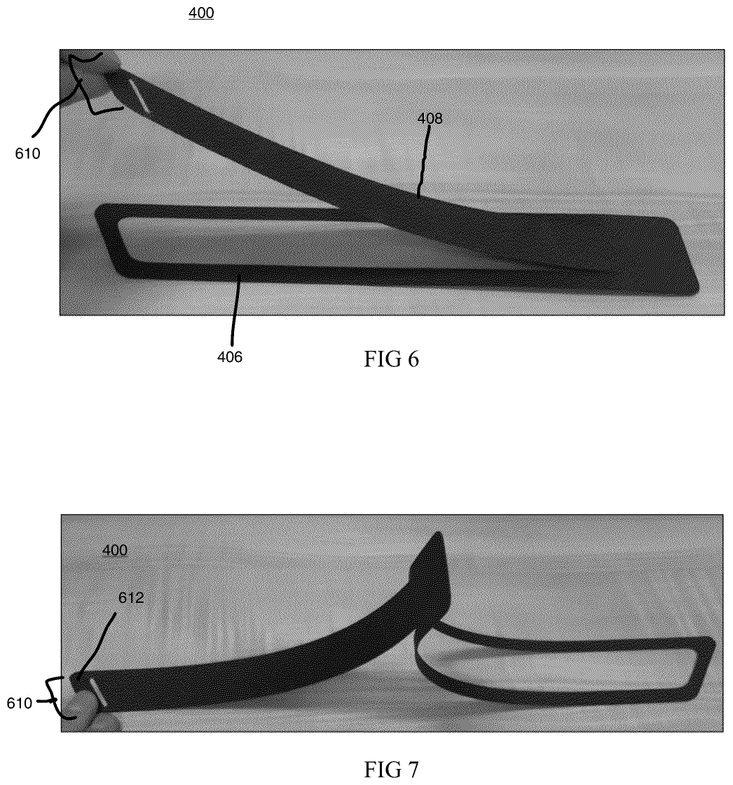

FIG. 6 is a perspective view of installation tool 400 in a partially open position, according to an embodiment. FIG. 7 is a perspective view of installation tool 400 in an open position, according to an embodiment. Also included is angled end 610.

In one embodiment, installation tool 400 has an angled end 610, which is cut at an angle to allow the installation tool 400 to fit through gap 214 easier. In one embodiment, the point of the angled end, i.e., insertion point 612, allows the installation tool 400 to be inserted more readily between the truck bed and the tailgate.

In one embodiment, slot 404 is cut such that it is parallel to the end of strap receiving portion 408. In embodiments with an angled end 610, this means that slot 404 is cut at a similar angle as the angled end 610. In one embodiment, slot 404 is cut at an angle such that it is not parallel to the end of strap receiving portion 408. In one embodiment, slot 404 is at an angle such that the width of slot 404 is longer than the width of strap receiving portion 408. In one embodiment, slot 404 is at an angle but the width of slot 404 is not longer than the width of strap receiving portion 408. In one embodiment, there are two or more slots 404 at different angles such that they intersect. In one embodiment, slot 404 is curved. In one embodiment, slot 404 is a semi-circle.

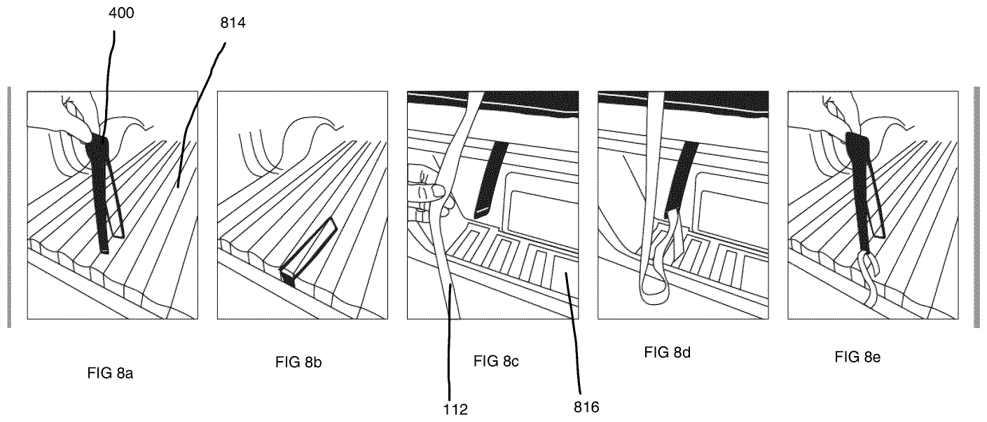

FIG. 8a-8e are collectively the process of using installation tool 400 to install a tailgate pad, according to an embodiment. Also included is truck bed 814 and bumper 816.

In FIG. 8a, tailgate 77 is lowered to a point where the installation tool 400 can be fit into gap 214. The amount that tailgate 77 needs to be lowered varies based on the truck, but typical cases will have tailgate 77 lowered roughly 30-90 degrees from vertical to allow straps to fit through gap 214.

In FIG. 8b, installation tool 400 is opened into an L position (similar to how it is shown in at least FIG. 7) such that strap receiving portion 408 is slotted through gap 214, and retaining portion is resting against truck bed 814 and preventing installation tool 400 from falling all the way though gap 214.

FIG. 8c shows strap receiving portion sticking out from gap 214 and in front of bumper 816. In some cases when the user is feeding strap receiving portion 408 through gap 214 it is possible for strap receiving portion 408 to slip behind bumper 816, in which case the user can easily manually pull to be more accessible. Here, front side straps 112a-112d (or simply strap 112) are brought in. In one embodiment, one installation tool 400 is used per strap 112, for example if there are four instances of strap 112 then four installation tools 400 would be needed.

In one embodiment, each installation tool 400 has at least one slot 404 such that at least one strap 112 can be retained by a single installation tool. For example, installation tool 400 has two slots 404 and can retain two straps 112 at once. In one embodiment, each installation tool 400 has a plurality of slots 404 such that a plurality of straps 112 can be retained by a single installation tool. For example, installation tool 400 has three slots 404 and can retain three straps 112 at once.

FIG. 8d shows strap 112 being fit through slot 404. When doing this, the user should be careful not to twist the strap so that it will lay flat when installation is finished. It should be noted that installation tool 400 still functions when the strap is twisted.

Finally, FIG. 8e shows tailgate 77 in an open position to where the user can pull the straps 112 through gap 214 to the other side. From here, a user can easily connect the front side straps 112a-d to strap receiving feature 402a-d.

With this method and installation tool 400, a single person is easily able to install a tailgate pad without help, and with reduced risk of injury or struggle during the process.

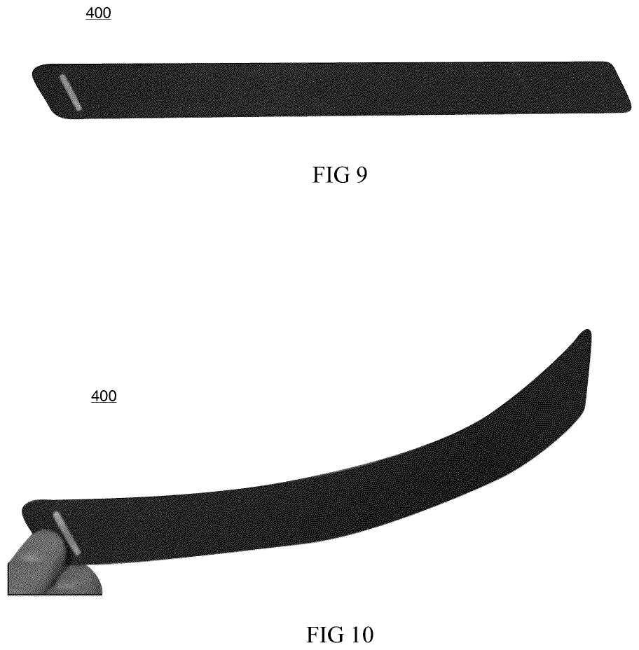

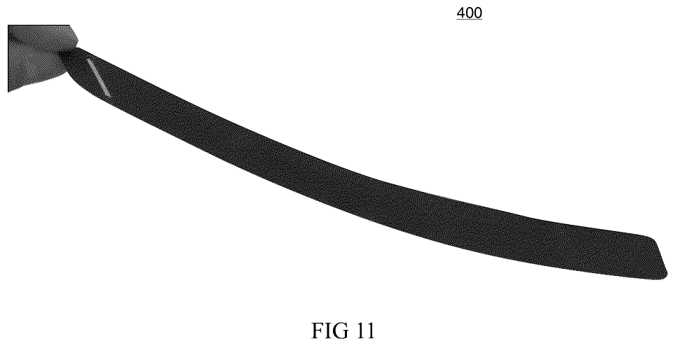

FIG. 9 is a perspective view of installation tool 400, according to an embodiment. FIG. 10 is a perspective view of installation tool 400 in a curved position, according to an embodiment. FIG. 11 is a perspective view of installation tool 400 in a curved position, according to an embodiment.

In one embodiment, as shown in at least FIGS. 9 and 10 installation tool 400 has a curve or bend to retain it and prevent it from falling all the way through gap 214.

In one embodiment, the retaining portion 406 is formed by bending the end of the installation tool 400 such that the tool forms a L shape. In one embodiment, the bent portion that forms retaining portion 406 is just enough to prevent the installation tool 400 from falling through the gap. For example, retaining portion 406 can be 1 in long. Installation tool 400 can be sent in a flat state, where the user bends installation tool 400 along a crease.

In one embodiment, installation tool 400 has a uniform texture on both sides. In one embodiment, installation tool 400 has a logo or product marking on at least one side. In one embodiment, installation tool 400 has a logo or product marking on both sides. In one embodiment, installation tool 400 has use instructions on at least one side. In one embodiment, installation tool 400 has use instructions on both sides. In one embodiment, installation tool 400 has a rough texture or gripping surface where the user would hold it to pull straps 112 through gap 214.

In one embodiment, at least one installation tool 400 is provided alongside a tailgate pad. In one embodiment, an appropriate number of installations tools 400 are provided alongside a tailgate pad and are made to accommodate for the straps of said tailgate pad. In one embodiment, the tailgate pad comes with a slot or pouch to store the provided installation tools 400.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

We claim the following:

1. An installation tool comprising:
a strap receiving portion, wherein a slot passes through the strap receiving portion, the slot fit to receive a strap; and
a retaining portion, wherein the retaining portion prevents the installation tool from falling through a gap.

2. The installation tool of claim 1 wherein, the strap receiving portion and the retaining portion are formed from the same piece of material.

3. The installation tool of claim 1 further comprising:
an angled end, wherein the angled end is cut at an angle to allow the installation tool to fit through the gap easier.

4. The installation tool of claim 1 wherein, the slot is cut such that it is parallel to the end of the strap receiving portion.

5. The installation tool of claim 1 wherein, the slot is cut at an angle such that it is not parallel to the end of the strap receiving portion.

6. The installation tool of claim 1 wherein, the slot is slightly wider than a target strap thickness such that when the target strap is pulled, friction causes the strap to bind in the slot.

7. The installation tool of claim 1 wherein, the retaining portion is opened into an L position such that the strap receiving portion is slotted through the gap, and the retaining portion is resting against a truck bed and preventing the installation tool from falling all the way though the gap.

8. An installation tool comprising:
a strap receiving portion, wherein a slot passes through the strap receiving portion, the slot fit to receive a strap; and
a retaining portion, wherein the retaining portion prevents the installation tool from falling through a gap, wherein the retaining portion is opened into an L position such that the strap receiving portion is slotted through the gap, and the retaining portion is resting against a truck bed and preventing the installation tool from falling all the way though the gap.

9. The installation tool of claim 8 wherein, the strap receiving portion and the retaining portion are formed from the same piece of material.

10. The installation tool of claim 8 further comprising:
an angled end, wherein the angled end is cut at an angle to allow the installation tool to fit through the gap easier.

11. The installation tool of claim 8 wherein, the slot is cut such that it is parallel to the end of the strap receiving portion.

12. The installation tool of claim 8 wherein, the slot is cut at an angle such that it is not parallel to the end of the strap receiving portion.

13. The installation tool of claim 8 wherein, the slot is slightly wider than a target strap thickness such that when the target strap is pulled, friction causes the strap to bind in the slot.

14. A tailgate pad installation kit comprising:
a front side;
a plurality of front side straps coupled to the front side;
a back side;
a plurality of strap retaining features coupled to the back side;
a top side; and
an installation tool comprising;
a strap receiving portion, wherein a slot passes through the strap receiving portion, the slot fit to receive a strap; and
a retaining portion, wherein the retaining portion prevents the installation tool from falling through a gap.

15. The installation tool of claim 14 wherein, the strap receiving portion and the retaining portion are formed from the same piece of material.

16. The installation tool of claim 14 further comprising:
an angled end, wherein the angled end is cut at an angle to allow the installation tool to fit through the gap easier.

17. The installation tool of claim 14 wherein, the slot is cut such that it is parallel to the end of the strap receiving portion.

18. The installation tool of claim 14 wherein, the slot is cut at an angle such that it is not parallel to the end of the strap receiving portion.

19. The installation tool of claim 14 wherein, the slot is slightly wider than a target strap thickness such that when the target strap is pulled, friction causes the strap to bind in the slot.

20. The installation tool of claim 14 wherein, the retaining portion is opened into an L position such that the strap receiving portion is slotted through the gap, and the retaining portion is resting against a truck bed and preventing the installation tool from falling all the way though the gap.
